(19) United States
(12) Patent Application Publication
(10) Pub. No.: US 2024/0416463 A1
(43) Pub. Date: Dec. 19, 2024

(54) LASER PROCESSING WITH ACOUSTIC MONITORING

(71) Applicant: Coherent Switzerland AG, Belp (CH)

(72) Inventor: Florian FURGER, Rüschegg-Heubach (CH)

(73) Assignee: Coherent Switzerland AG, Belp (CH)

(21) Appl. No.: 18/335,533

(22) Filed: Jun. 15, 2023

(51) Int. Cl. B23K 26/70; B23K 26/03; B23K 26/06; G01N 29/14; G01N 29/40; G01N 29/42; H04R 1/40; H04R 3/00

(52) U.S. Cl. CPC B23K 26/705; B23K 26/032; B23K 26/0648; B23K 26/707; G01N 29/14; G01N 29/40; G01N 29/42; H04R 1/406; H04R 3/005; B23K 26/034

(57) ABSTRACT

An apparatus for laser processing a workpiece includes a laser processing head that directs a laser beam to the workpiece and focuses the laser beam, and a collection of three or more acoustic sensors attached to the laser processing head. The acoustic sensors are distributed about an optical axis of the laser beam as incident on the workpiece. Mounting of the acoustic sensors to the laser processing head is advantageous for serial processing of multiple workpieces and of multiple different portions of a workpiece. Alignment between the acoustic sensors and the laser beam is maintained during movement of the laser processing head. Electrical signals produced by each acoustic sensor in response to acoustic signals incident thereon may be amplified and/or spectrally filtered. Both amplification and spectral filtering may be independently adjustable for each acoustic sensor. The acoustic sensors may be sensitive to acoustic frequencies higher than 20 kilohertz.

### TECHNICAL FIELD OF THE INVENTION

The present invention relates to monitoring laser processing of a workpiece. The present invention relates in particular to laser process monitoring based on detection of acoustic emission from the workpiece.

### DISCUSSION OF BACKGROUND ART

Beams of high-power laser radiation are used to machine, weld, and otherwise work a wide range of materials, including metals, plastics, and glass. Common industrial laser processes include cutting, scribing, drilling, marking, welding, heat treating, and annealing. A typical laser processing apparatus includes a laser source that generates a laser beam, and a laser processing head that directs the laser beam to a workpiece and focuses the laser beam on the workpiece. The small and well-controlled transverse dimensions of the laser beam allow for a narrow heat-affected zone. Laser processing can therefore be performed with a very high accuracy. Additionally, laser processing usually offers higher processing speed than other techniques and is relatively flexible regarding the geometry of the workpiece and laser processing task to be performed thereon.

For many laser processes, the laser-material interaction is highly nonlinear, and the processed material rapidly progresses through a series of different states. In laser welding, for example, the welded portion of the workpiece may progress through melting, mixing, solidification, and possibly defect-formation in a fraction of a millisecond. Such high nonlinearity and short state-lifetimes render the outcome of the laser process particularly sensitive to fluctuations in the working environment as well as variations in the local physical properties of the workpiece. A laser process may be afflicted by a variety of issues when process parameters fall outside their specifications. In the example of laser welding, potential issues include spatter, insufficient weld penetration, blow-through holes, and crack formation. The quality and reproducibility of the laser process may benefit from real-time process monitoring to detect excessive process parameter variation and correct or compensate for such variation, or at least report or log the variance.

Three of the most commonly employed techniques for laser process monitoring are surface temperature measurements, high-speed image capture, and optical coherence tomography. Surface temperature measurements provide very limited information. High-speed cameras are expensive and cannot see beneath the surface of the material. Optical coherence tomography provides a subsurface view but is typically even more expensive to implement than high-speed cameras.

A more affordable laser process monitoring solution is offered by detection and analysis of optical radiation emitted from or scattered/reflected by the portion of the workpiece being processed by the laser beam. Some of that optical radiation propagates backwards to the laser processing head and can be collected there and forwarded to suitable detectors for analysis. The backward-propagating radiation provides real-time information about the processed material both at and beneath its surface. The backward-propagating radiation typically includes a back-reflected/scattered portion of the process laser beam, luminous radiation, and thermal radiation. Due to their different spectral properties, these three different types of radiation can be detected separately by three detectors.

### SUMMARY OF THE INVENTION

Acoustic monitoring may be used to obtain a different type of information about the laser process than that provided by optical monitoring. For example, cracking and phase transitions in a laser welding process generate detectable acoustic signals. Acoustic signals may also convey information about other aspects of the laser welding process, such as the weld penetration depth and the porosity of the weld nugget. Useful acoustic monitoring requires distinguishing acoustic signals originating from the laser process from other acoustic signals. In industrial laser processing, the environment is often very noisy. A piezoelectric acoustic sensor affixed to the workpiece benefits from this direct coupling to detect acoustic signals from the workpiece more efficiently than acoustic signals from the environment. However, in many industrial applications, a large number of workpieces are processed in series at a high rate, and it may not be feasible to affix a piezoelectric acoustic sensor to each workpiece. Remote detection of airborne acoustic signals may be the only viable option in such scenarios.

Noise reduction techniques, such as spectral subtraction and beamforming, may be necessary when relying on remote detection of acoustic signals. Beamforming is applicable to setups with several acoustic sensors. The output signals from the individual acoustic sensors are combined in a manner that maximizes the collective sensitivity of the acoustic sensors to acoustic signals originating from the location of the laser process. Spectral subtraction is applied individually to each involved acoustic sensor. Spectral subtraction entails estimating an acoustic background and subtracting this acoustic background from the measured acoustic signal.

Disclosed herein is an apparatus, and associated method, for laser processing with acoustic monitoring of the laser process based on remote detection of airborne acoustic signals. The acoustic monitoring is performed with a collection of acoustic sensors mounted to the laser processing head that directs the process laser beam to the workpiece. Mounting of the acoustic sensors to the laser processing head is advantageous for serial processing of multiple workpieces and serial processing of multiple different portions of a workpiece. The target location for the laser beam typically coincides with the laser beam focus. Thus, once the acoustic sensors have been aligned with respect to the laser beam focus, that same alignment is automatically maintained when transitioning between different workpieces or different locations on an individual workpiece, provided that the laser beam propagation direction from the laser processing head to the workpiece is fixed with respect to the laser processing head. The alignment may be tolerant to some amount of steering of the laser beam propagation direction, relative to the laser processing head, for example as required in spiral welding or wobble welding tasks.

In some embodiments, amplification with separate gain adjustment for each individual acoustic sensor has been advantageous for optimizing sensitivity to a particular acoustic feature deemed to be of interest. Spectral filtering, with separate adjustment of the spectral filter settings, has been found to be helpful for the same purpose in some embodiments. A graphical user interface may aid a user to quickly and easily optimize the gain and/or spectral filter settings for each acoustic sensor. We have also found that favorable signal-to-background ratios can be achieved by operating outside the audible frequency range. The acoustic sensors may therefore be designed to be sensitive to non-audible frequencies above 20 kilohertz, and spectral filtering may be invoked to exclude audible frequencies.

In one aspect of the invention, an apparatus for laser processing a workpiece and monitoring the laser processing includes a laser processing head, a collection of three or more acoustic sensors, and a plurality of amplifiers. The laser processing head is configured to direct a laser beam to a workpiece. The laser processing head includes an objective lens configured to focus the laser beam. The collection of three or more acoustic sensors are attached to the laser processing head and distributed about an optical axis of the laser beam as incident on the workpiece. Each of the acoustic sensors is configured to produce an electrical signal in response to an acoustic signal incident thereon. Each of the plurality of amplifiers (a) is electrically connected to a respective one of the acoustic sensors, (b) is configured to amplify the electrical signal from the respective acoustic sensor, and (c) has an independently adjustable gain.

In another aspect of the invention, a method for laser processing a workpiece and monitoring the laser processing includes steps of directing a laser beam from a laser processing head to a workpiece, focusing the laser beam with an objective lens of the laser processing head, and detecting acoustic emission from the workpiece with a collection of three or more acoustic sensors attached to the laser processing head and distributed about an optical axis of the laser beam as incident on the workpiece. The step of detecting includes each acoustic sensor producing an electrical signal in response to an acoustic signal incident thereon. The method further includes steps of amplifying the electrical signal from each acoustic sensor and adjusting, independently for each acoustic sensor, a gain of the amplifying step.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates a laser processing apparatus with acoustic monitoring, according to an embodiment. The apparatus includes a laser processing head and a collection of acoustic sensors attached thereto. The acoustic sensors are aimed at a target location irradiated by a laser beam directed by the laser processing head.

FIG. 2 illustrates exemplary positioning of acoustic sensors in the apparatus of FIG. 1.

FIG. 3 illustrates acoustic signal processing circuitry configured to process an electrical signal generated by an individual one of the acoustic sensors of the FIG. 1 apparatus in response to an acoustic signal incident thereon, according to an embodiment.

FIG. 4 illustrates acoustic signal processing circuitry configured to process and beamform electrical signals obtained from a collection of acoustic sensors in the FIG. 1 apparatus, according to an embodiment.

FIGS. 5A and 5B illustrate elements of a microphone that may be implemented as an acoustic sensor in the FIG. 1 apparatus, according to an embodiment.

FIGS. 6A and 6B illustrate elements of another microphone that is similar to the microphone of FIGS. 5A and 5B, but further includes one or more light sources configured to emit pilot beams, according to an embodiment. The pilot beams may be used to align the microphone in the FIG. 1 apparatus.

FIG. 7 illustrates an alternative configuration of the FIG. 1 apparatus wherein one or more acoustic sensors are aimed at the target location irradiated by the laser beam directed by the laser processing head, and at least one other acoustic sensor is aimed at another location, according to an embodiment.

### DETAILED DESCRIPTION OF THE INVENTION

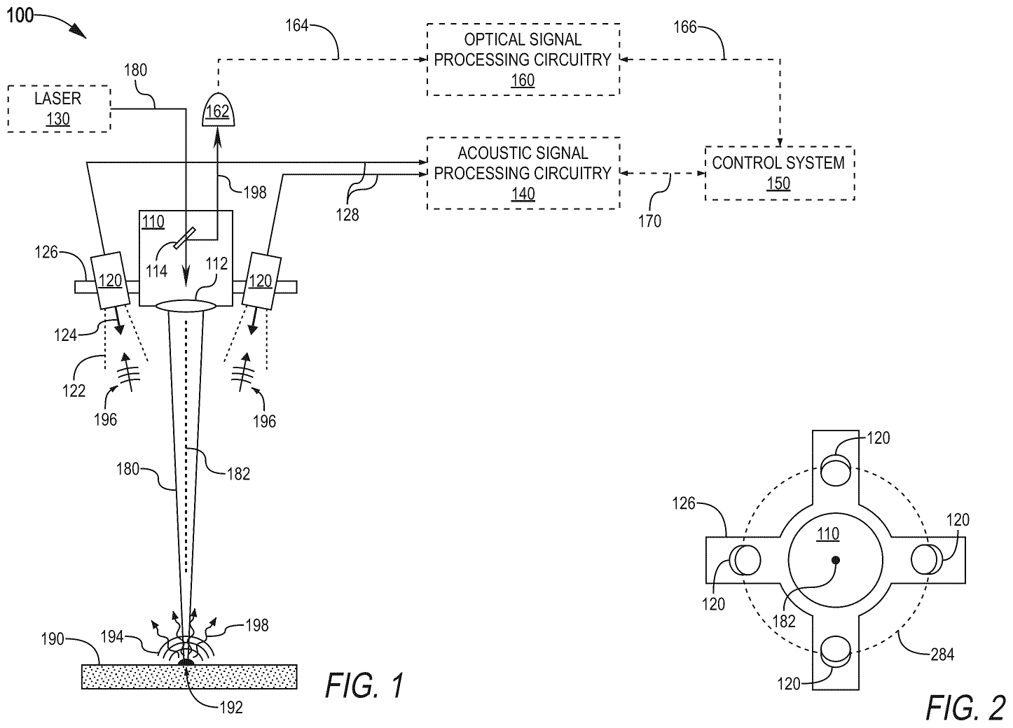

Referring now to the drawings, wherein like components are designated by like numerals, FIG. 1 is a sideview of one laser processing apparatus 100 with acoustic monitoring. Apparatus 100 includes a laser processing head 110 and a collection of acoustic sensors 120 attached to processing head 110. Processing head 110 directs a laser beam 180 to a workpiece 190 to laser process workpiece 190. Apparatus 100 may also include a laser 130 that generates laser beam 180. Laser 130 may deliver laser beam 180 to processing head 110 via an optical fiber.

The laser process performed by apparatus 100 includes, for example, welding, cutting, scribing, drilling, marking, heat treating, and/or annealing workpiece 190. Workpiece 190 may include multiple parts. For example, workpiece 190 may include two or more separate parts to be welded together by laser beam 180. Workpiece 190 may be held in a workstation (not shown in FIG. 1).

Processing head 110 includes an objective lens 112 that focuses laser beam 180. In a typical laser process, the target location 192 for laser beam 180 on workpiece 190 coincides with the focus of laser beam 180. Laser beam 180 has an optical axis 182. In objective lens 112, optical axis 182 may be coaxial with the optical axis of objective lens 112. Optionally, processing head 110 includes internal beam-steering functionality (not shown in FIG. 1) to steer laser beam 180 to target location 192. This internal beam-steering functionality may include one or more galvanometer mirrors. In embodiments that implement such beam-steering functionality before objective lens 112, optical axis 182 may deviate from the optical axis of objective lens 112, depending on how laser beam 180 is being steered.

Laser processing of workpiece 190 by laser beam 180 generates airborne acoustic emission 194. Each acoustic sensor 120 detects a portion of such acoustic emission 194 in the form of an acoustic signal 196 incident on the acoustic sensor. Apparatus 100 includes at least three acoustic sensors 120 (two are depicted in the sideview of FIG. 1). Acoustic sensors 120 are distributed about optical axis 182. In the implementation depicted in FIG. 1, optical axis 182 is straight between objective lens 112 and workpiece 190. In an alternative implementation, processing head 110 includes one or more optical elements that fold or bend optical axis 182 after objective lens 112. In this alternative implementation, acoustic sensor 120 are distributed about optical axis 182, as optical axis 182 is oriented where laser beam 180 is incident on workpiece 190.

FIG. 2 illustrates exemplary positioning of acoustic sensors 120 in apparatus 100. FIG. 2 views processing head 110 from workpiece 190, along a viewing direction that is parallel to optical axis 182 and opposite the propagation direction of laser beam 180. Acoustic sensors 120 are mounted in a common bracket 126 that is affixed to processing head 110. Common bracket 126 may be replaced by two or more separate brackets, each of which is affixed to processing head 110 and holds a subset of the collection of acoustic sensors 120. One or more acoustic sensors 120 may be affixed directly to processing head 110.

In the example depicted in FIG. 2, apparatus 100 includes four acoustic sensors 120. These four acoustic sensors 120 are evenly distributed about optical axis 182. The four acoustic sensors 120 are all disposed at the same distance from optical axis 182, as indicated by circle 284 centered on optical axis 182. This example is readily extendable to only three acoustic sensors 120 or more than four acoustic sensor 120. In a more general embodiment, acoustic sensors 120 may be evenly or unevenly distributed about optical axis 182. An uneven distribution may be necessitated by spatial constraints or deemed optimal for a particular laser processing task.

Referring again to FIG. 1, each acoustic sensor 120 generates an electrical signal 128 in response to acoustic signal 196 incident thereon. Acoustic sensors 120 may be sensitive to acoustic frequencies extending above 20 kilohertz (kHz), e.g., up to 50 kHz. For comparison, the audible frequency range is (typically) from 50 Hertz (Hz) to 20 kHz. In one embodiment, each acoustic sensor is sensitive to acoustic frequencies in the range from 0.5 to 50 kHz. Sensitivity to acoustic frequencies above 20 kHz may be advantageous because the noise level tends to be higher within the audible frequency range than above the audible frequency range.

Each acoustic sensor 120 has a field of view 122 and a pointing direction 124 centered in FOV 122. Acoustic sensors 120 may be aimed at target location 192 to optimally detect acoustic emission 194 originating therefrom. Herein, “aiming” may refer to physical aiming of acoustic sensors 120 and/or, in the case of multiple acoustic sensors 120, beamforming to optimize the sensitivity of a combined signal from the multiple acoustic sensors 120 to a particular location. Physical aiming is applied to individual acoustic sensors 120. Physical aiming of an acoustic sensor 120 may entail aiming pointing direction 124 at a particular location or, more generally, orienting acoustic sensor 120 such that this particular location is within FOV 122.

Acoustic sensors 120 may be aligned prior to laser processing of a workpiece 190 based on acoustic signals emitted by an acoustic emitter positioned at a location corresponding to target location 192, e.g., at the location where laser beam 180 comes to a focus. The orientations, and optionally positions, of acoustic sensors 120 may then be adjusted to optimally detect acoustic signals emitted by this acoustic emitter. The acoustic emitter may be a piezoelectric actuator. The acoustic emitter may generate an acoustic signal at one frequency within a frequency range of interest, to calibrate the collection of acoustic sensors 120. In embodiments where the sensitivity range of acoustic sensors 120 extends beyond the audible frequency range, the piezoelectric actuator may operate at a frequency above 20 kHz, for example in the range between 30 and 50 KHz.

Many laser processing tasks involve tracing a path on the workpiece with the laser beam, and/or irradiating a series of locations a distance apart from each other. To perform such laser processing tasks, processing head 110 may be mounted on a robotic arm capable of translating and/or rotating processing head 110. Because acoustic sensors 120 are mounted to processing head 110, acoustic sensors 120 will move with laser processing head 110 during such movement. Alternatively, or in combination therewith, workpiece 190 may held in a workstation capable of moving workpiece 190 to expose different portions of workpiece 190 to laser beam 180. Whether processing head 110 is being moved relative to workpiece 190 or vice versa, the relative alignment between acoustic sensors 120 and target location 192 is maintained. If utilizing internal beam-steering functionality of processing head 110 to steer laser beam 180 relative to workpiece 190, the relative alignment between acoustic sensors 120 and target location 192 may be affected by the beam steering. However, the alignment may be tolerant to at least minor steering of the propagation direction of laser beam 180 from processing head 110. For example, the alignment may be tolerant to the amount of beam steering required to (a) perform spiral-welding-type spot welding or (b) add a wobble-motion to a line welding task. In scenarios with substantial beam steering, acoustic sensors 120 may be configured with a relatively large FOV 122.

Apparatus 100 may include acoustic signal processing circuitry 140 that processes electrical signals 128 from acoustic sensors 120 to produce an electrical output signal 170 containing information about the laser process performed by laser beam 180 on workpiece 190. The information conveyed by output signal 170 may include variation in laser power and/or focus, cracking and/or material inhomogeneity of the workpiece, and lack of process activity. Apparatus 100 may also include a control system 150 that receives output signal 170. Control system 150 may make adjustments to the operation of processing head 110 and/or laser 130 in response to output signal 170. Control system 150 may also control aspects of the signal processing performed by acoustic signal processing circuitry 140.

In addition to acoustic emission 194, laser processing of workpiece 190 by laser beam 180 also produces optical radiation 198 propagating away from target location 192. Optical radiation 198 typically includes a backscattered/backreflected portion of laser beam 180, luminous radiation generated from laser beam 180, and blackbody thermal radiation. A portion of optical radiation 198 propagates backwards toward processing head 110 and may be collected by objective lens 112.

In one embodiment, apparatus 100 may be configured to optically monitor the laser process, performed by laser beam 180, based on such backward-propagating optical radiation 198. This embodiment of apparatus 100 thus offers optical monitoring in conjunction with the acoustic monitoring facilitated by acoustic sensors 120. In this embodiment, processing head 110 is configured to separate out at least some of backward-propagating optical radiation 198 collected by objective lens 112. For example, processing head 110 may include a beam splitter 114 that splits off backward-propagating optical radiation 198 to one or more optical detectors 162. Optical detector(s) 162 may be included in apparatus 100, or apparatus 100 may have an output port or optical fiber that can be used to couple backward-propagating optical radiation 198 to one or more optical detectors 162 obtained separately from apparatus 100.

Each optical detector 162 generates an electrical signal 164 in response to optical radiation 198 incident thereon. Apparatus 100 may include optical signal processing circuitry 160 that processes electrical signals 164 to produce an electrical output signal 166. Output signal 166 contains information about the laser process, such as the reflectivity and/or temperature of target location 192. In embodiments of apparatus 100 that include control system 150, optical signal processing circuitry 160 may relay output signal 166 to control system 150, and/or aspects of the signal processing performed by optical signal processing circuitry 160 may be controlled by control system 150.

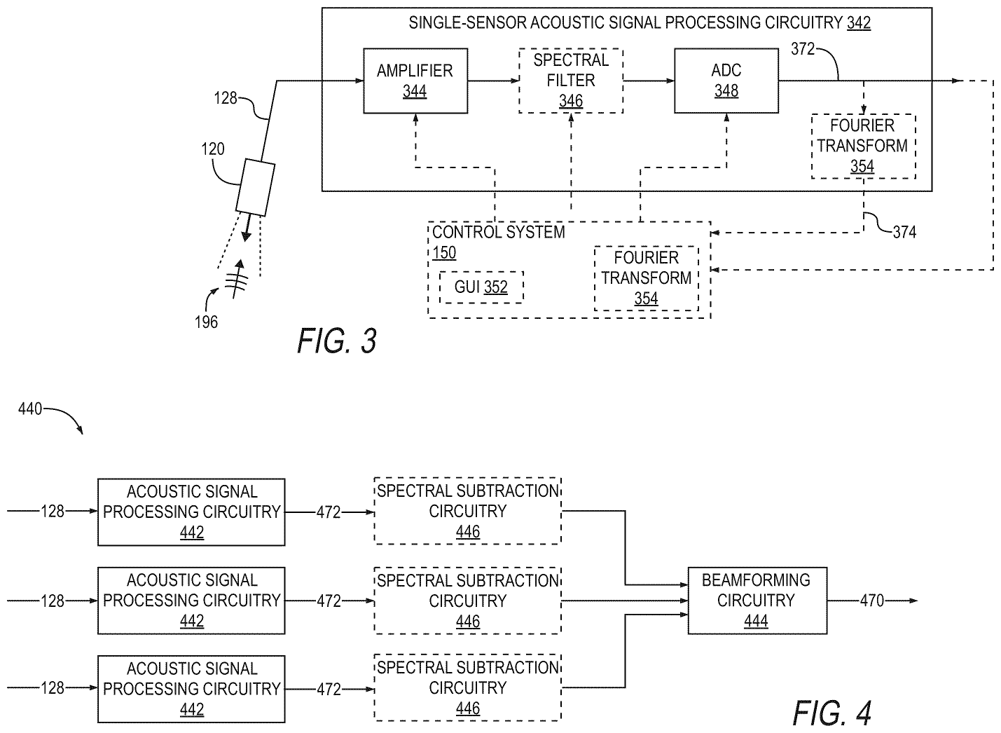

FIG. 3 illustrates exemplary single-sensor acoustic signal processing circuitry 342 configured to process electrical signal 128 from an individual acoustic sensor 120. Acoustic signal processing circuitry 140 of apparatus 100 may include one instance of single-sensor circuitry 342 for each acoustic sensor 120 of apparatus 100. Circuitry 342 includes an amplifier 344 and an analog-to-digital converter (ADC) 348. Circuitry 342 may also include a spectral filter 346. Amplifier 344 amplifies electrical signal 128. Spectral filter 346 filters the frequency-content of electrical signal 128. ADC 348 converts electrical signal 128 from analog to digital form. The order of amplifier 344, spectral filter 346, and ADC 348 may be different from that depicted in FIG. 3. Furthermore, one or more of amplifier 344, spectral filter 346, and ADC 348 may be integrated with acoustic sensor 120.

Processing of electrical signal 128 by single-sensor circuitry 342 produces a single-sensor electrical output signal 372. Single-sensor output signal 372 indicates the acoustic pressure on acoustic sensor 120 as a function of time. Single-sensor circuitry 342 may communicate single-sensor output signal 372 to control system 150. Optionally, circuitry 342 includes a Fourier transform module 354 that transforms single-sensor output signal 372 from the time domain to the spectral domain to determine the spectrum 374 of single-sensor output signal 372. Single-sensor circuitry 342 may communicate spectrum 374 to control system 150. Control system 150 may display single-sensor output signal 372 and/or spectrum 374 to a user, for example on a graphical user interface (GUI) 352. The user may then use this data to adjust the laser process and/or the signal processing performed by single-sensor circuitry 342.

Fourier transform module 354 may be shared between two or more instances of circuitry 342 in apparatus 100. In one implementation, acoustic signal processing circuitry 140 includes one instance of circuitry 342 for each acoustic sensor 120, and these instances of circuitry 342 are implemented on a common circuit board. This circuit board may include a single Fourier transform module 354 that is applied to output signal 372 for each acoustic sensor 120 in a time-shared manner. Alternatively, Fourier transform module 354 may be implemented in control system 150.

In one embodiment, the gain applied by amplifier 344 is adjustable. When this embodiment of single-sensor circuitry 342 is implemented in apparatus 100 for each acoustic sensor 120, the applied gain may be independently adjustable for each acoustic sensor 120. Such independent gain adjustment has been found advantageous for optimizing the information contained in single-sensor output signal 372. In one example, independent gain adjustment for each acoustic sensor 120 is used to bring acoustic features of particular interest to an optimal level for each individual acoustic sensor 120. The optimal level may be a certain margin away from both a noise floor and a saturation level. Several different circumstances can cause the optimal gain setting to be different for different acoustic sensors. For example, different acoustic sensors 120 may have different noise properties and/or alignment properties and therefore produce dissimilar electrical signals 128. Additionally, different acoustic sensors 120 may be dedicated to detection of acoustic signals 196 of different acoustic frequencies of different respective strengths.

Control system 150 may be configured to (a) present, to a user, a discrete set of gain values for amplifier 344 for each acoustic sensor 120, and (b) receive a user's selection of one of these gain values for each amplifier 344. GUI 352 may handle these output and input functions. To help a user make the optimal selections, GUI 352 may display single-sensor output signal 372 or the associated spectrum 374 for each acoustic sensor 120.

Spectral filter 346 may include a high-pass filter, a low-pass filter, a bandpass filter, a notch filter, or a combination thereof. Spectral filter 346 may serve to remove noise at frequencies outside the range of acoustic frequencies to which acoustic sensor 120 is sensitive. For example, if acoustic sensor 120 is sensitive to acoustic frequencies between 0.5 and 50 kHz, spectral filter 346 may filter out frequencies outside this range, since frequencies outside this range do not contain information about the laser process. Alternatively, or in combination therewith, spectral filter 346 may select a particular acoustic frequency range that is within, but narrower than, the sensitivity range of acoustic sensor 120. Such filtering may be based on the identification of certain acoustic frequencies conveying a particular type of useful information about the laser process.

In one embodiment, at least one acoustic sensor 120 of apparatus 100 is sensitive to acoustic frequencies both above and below 20 kHz, but the associated spectral filter 346 excludes acoustic frequencies that are less than 20 kHz (where the noise level is typically higher). The associated spectral filter 346 may retain all acoustic signals above 20 kHz. Alternatively, this spectral filter 346 may retain only one or more narrower frequency ranges above 20 kHz, for example a set of frequency ranges coinciding with certain acoustic features of interest or a more general frequency range such as 25-50 kHz. Although the noise level is typically higher within the audible frequency range, at least one acoustic sensor 120 may be associated with a spectral filter 346 that retains acoustic frequencies within the audible frequency range. This spectral filter 346 may select a particular range, or ranges, of audible frequencies and reject all other frequencies.

An acoustic feature may appear in electrical signal 128 both at its fundamental frequency and at one or more harmonics thereof. In situations where the fundamental frequency of an acoustic feature is within the audible frequency range and a harmonic thereof is above the audible frequency range, the harmonic may be more clearly distinguishable from noise. Spectral filter 346 may retain a harmonic of a certain acoustic feature while excluding its fundamental frequencies within the (typically more noisy) audible frequency range. The retained harmonic is, for example, a second harmonic.

Control system 150 may configure each spectral filter 346, optionally according to a user input. In one example, control system 150 (a) presents, to a user, a set of frequency ranges for spectral filter 346 for each acoustic sensor 120, and (b) receives a user's selection of one of these frequency ranges for each spectral filter 346. Control system 150 then configures each spectral filter 346 to limit the spectral content of the corresponding electrical signal 128 to the selected frequency range. Control system 150 may utilize GUI 352 for the purpose of communicating spectral ranges with the user, in a manner similar to that discussed for gain values of amplifiers 344.

Optionally, control system 150 controls certain aspects of the operation of ADC 348, such as the sampling rate and/or bit depth. Control system 150 may control the sampling rate and/or bit depth based on a user input in a manner similar to that discussed above for the gain of amplifier 344 and frequency ranges for spectral filter 346. The sampling rate of ADC 348 may define the overall sampling rate of single-sensor circuitry 342. In accordance with Nyquist's theorem, the overall sampling rate of single-sensor circuitry 342 defines the highest acoustic frequency that can be accurately conveyed by single-sensor output signal 372. Specifically, the highest acoustic frequency that can be accurately represented in single-sensor output signal 372 is less than half the overall sampling rate of single-sensor circuitry 342. Thus, in scenarios where it is desired to accurately assess acoustic frequencies up to 50 kHz, the overall sampling rate of single-sensor circuitry 342 may exceed 100 kHz or, more preferably, 200 kHz. This relatively high sampling rate may be applied to one or more acoustic sensors 120. In one scenario, at least one acoustic sensor 120 and associated single-sensor circuitry 342 are cooperatively configured to assess acoustic frequencies up to 50 kHz, and the sampling rate for the associated ADC 348 exceed 100 kHz or, more preferably, 200 kHz.

In embodiments of apparatus 100 implementing circuitry 342 for a plurality of acoustic sensors 120, control system 150 or other electronic circuitry of apparatus 100 may interlace single-sensor output signals 372 to sample acoustic emission 194 at a higher effective sampling rate. Consider an example where the overall sampling rate of single-sensor circuitry 342 for each of N acoustic sensors 120 is at least 100 kHz or at least 200 kHz (wherein N is an integer greater than one). In this example, the associated single-sensor output signals 372 may be interlaced to sample acoustic emission 194 at an effective sampling rate of at least N×100 kHz or at least N×200 kHz.

As an alternative to spectral filter 346, spectral filtering may be integrated in the Fourier transform performed by Fourier transform module 354. The Fourier transform may utilize a window that selects only a particular range of frequencies, optionally according to a user input as discussed above. Generally, spectral filtering may help reduce the amount of processing that control system 150 and/or circuitry 342 (for each acoustic sensor 120) need to perform. Spectral filtering may thereby increase the rate at which control system 150 and/or circuitry 342 can produce the desired form of data. At least in scenarios where higher frequencies are to be filtered out, it may be advantageous to perform such filtering within circuitry 342 before analog-to-digital conversion by ADC 348, such that ADC 348 can operate at a lower sampling rate. It is also possible to filter out such higher frequencies by limiting the sampling rate of ADC 348, in which case ADC 348 acts as a spectral filter. A lower sampling rate by ADC 348 corresponds to less data to be subsequently processed by, e.g., Fourier transform module 354 and/or GUI 352. Spectral filtering may also be implemented in software of control system 150 as an alternative to or in combination with other spectral-filter implementations discussed herein.

Each of the above-mentioned operations of control system 150 based on user inputs may be replaced by automatic processing internally in control system 150. For example, control system 150 may execute an algorithm that evaluates single-sensor output signal 372 and/or spectrum 374 for each acoustic sensor 120. Based on such evaluation, control system 150 may then adjust one or more of the gain of amplifier 344, the spectral range(s) retained or excluded by spectral filter 346, and the sampling rate of ADC 348, for each acoustic sensor 120.

In a modification of single-sensor circuitry 342, one of amplifier 344 and ADC 348 is omitted. For example, amplifier 344 may be omitted if electrical signal 128 generated by acoustic sensor 120 is sufficiently strong without amplification or acoustic sensor 120 itself provides sufficient preamplification. ADC 348 may be omitted in embodiments where single-sensor output signals 372 from multiple acoustic sensors 120 are combined in analog form.

FIG. 4 illustrates exemplary acoustic signal processing circuitry 440 configured to beamform electrical signals obtained from the collection of acoustic sensors 120 in apparatus 100. In the depicted example, circuitry 440 processes electrical signals 128 from three acoustic sensors 120. Circuitry 440 may be configured to process electrical signals 128 from more than three acoustic sensors 120. Acoustic signal processing circuitry 440 is an embodiment of acoustic signal processing circuitry 140 that includes (a) one instance of single-sensor acoustic signal processing circuitry 442 for each acoustic sensor 120 followed by (b) beamforming circuitry 444.

Each instance of single-sensor acoustic processing circuitry 442 processes electrical signal 128 from a corresponding acoustic sensor 120 to produce single-sensor electrical output signal 472. Single-sensor acoustic processing circuitry 442 may be similar to single-sensor acoustic processing circuitry 342. Output signal 472 may include a temporal signal or a spectrum. Although not shown in FIG. 4, when output signal 472 is a temporal signal, circuitry 440 may also include Fourier transform module 354 to determine and output the spectrum of output signal 472. Similarly, when output signal 472 is a spectrum, circuitry 440 may also output the temporal signal from which this spectrum is generated.

Beamforming circuitry 444 combines the signals from at least some of acoustic sensors 120, preferably at least three, to produce a beamformed electrical output signal 470. Beamforming circuitry 444 performs this combination in a manner that optimizes the collective sensitivity of acoustic sensors 120 for a particular physical location, such as target location 192 and/or a focus of laser beam 180. Beamforming circuitry 444 may utilize any one of a multitude of beamforming techniques known in the art.

Optionally, circuitry 440 further includes spectral subtraction circuitry 446, for each acoustic sensor 120. Spectral subtraction circuitry 446 applies spectral subtraction to each single-sensor output signal 472 to reduce the noise level therein. The spectral subtraction may entail estimating an acoustic background contained in single-sensor output signal 472 and subtracting this acoustic background from single-sensor output signal 472. The acoustic background may be estimated from single-sensor output signal 472 itself. In an alternative embodiment, not depicted in FIG. 4, spectral subtraction is instead applied to beamformed output signal 470. Spectral subtraction may also be utilized as an alternative to beamforming. A related modification of circuitry 440 includes spectral subtraction circuitry 446 for each acoustic sensor 120 while beamforming circuitry 444 is omitted.

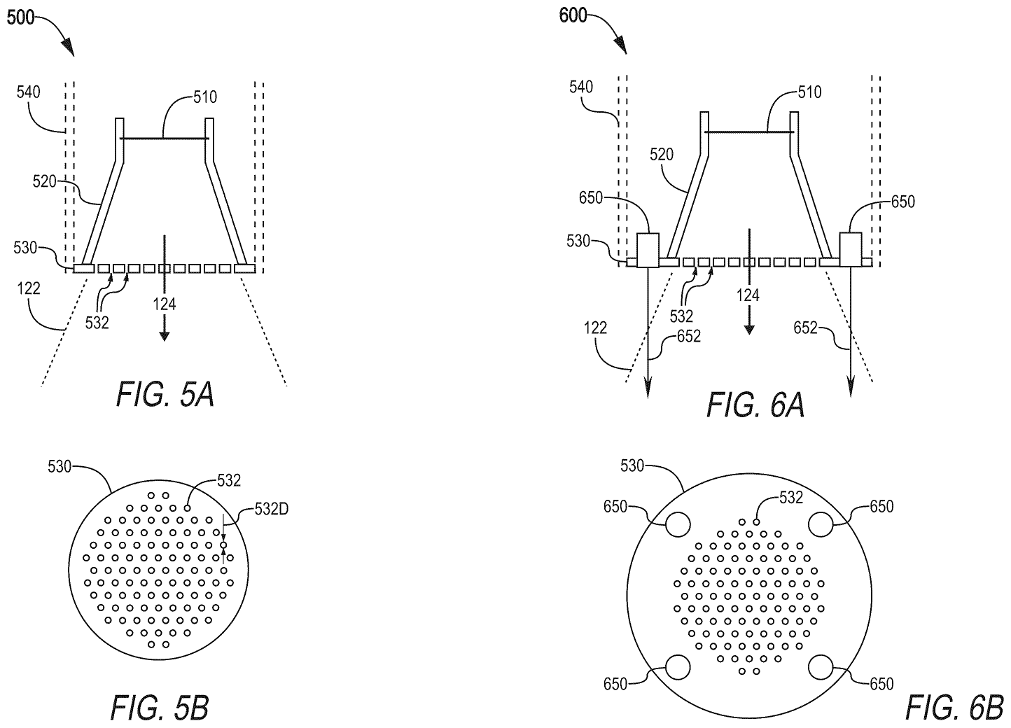

FIGS. 5A and 5B illustrate elements of one microphone 500 for detection of acoustic signals 196. Microphone 500 is an embodiment of acoustic sensor 120. Microphone 500 is optimized for detection of acoustic frequencies in a desired frequency range, such as acoustic frequencies greater than 20 kHz. FIG. 5A is a cross section of microphone 500 taken in a plane that contains pointing direction 124. Microphone 500 includes a diaphragm 510, a baffle 520, and a plate 530 with holes 532 therethrough. These three elements may be held in a housing 540. FIG. 5B shows plate 530, as viewed along pointing direction 124. Plate 530 covers the receiving aperture of baffle 520. In order for acoustic signal 196 to be properly detected by microphone 500, acoustic signal 196 must be transmitted by plate 530 and propagate through baffle 520 to diaphragm 510.

Microphone 500 may be a condenser microphone or a dynamic microphone. When implemented as a condenser microphone, diaphragm 510 forms one side of a capacitor (the other side of the capacitor is not depicted in FIG. 5). Movement of diaphragm 510 in response to acoustic signal 196 incident thereon generates a current between diaphragm 510 and the other side of the capacitor. Electrical signal 128 is derived from this current. When implemented as a dynamic microphone, movement of diaphragm 510 induces a current in an electromagnetic assembly, from which electrical signal 128 is derived.

Baffle 520 limits field of view 122. In the depicted embodiment, the transverse size of baffle 520, in dimensions orthogonal to pointing direction 124, increases in the direction toward plate 530. In this embodiment, baffle 520 may be conical. In another embodiment, the transverse size of baffle 520 decreases in the direction toward plate 530. Baffle 520 may be conical in this embodiment as well. In yet another embodiment, the transverse size of baffle 520 is constant between diaphragm 510 and plate 530. For example, baffle 520 may be cylindrical. Many other shapes are possible, and baffle 520 is not necessarily rotationally symmetric about pointing direction 124.

Holes 532 of plate 530 are sized to maximize transmission in a particular acoustic frequency range. In embodiments where diaphragm 510 and the associated transduction mechanism (condenser-type or dynamic) are sensitive to acoustic frequencies above 20 kHz, holes 532 may be sized to have higher relative transmission above 20 kHz than below. To achieve this characteristic, the transverse size 532D of holes 532 may be less than one millimeter, for example in the range between 0.3 and 1.0 millimeters. Holes 532 may be circular, in which case transverse size 532D is a diameter. Transverse size 532D of holes 532 may be adapted to optimize the sensitivity of microphone 500 to other acoustic frequencies. In one embodiment, transverse size 532D is optimized for detection of a particular audible acoustic frequency.

FIGS. 6A and 6B illustrate elements of another microphone 600 that includes one or more light sources 650 configured to emit pilot beams 652. Apart from the inclusion of light sources 650, microphone 600 is similar to microphone 500. FIGS. 6A and 6B show microphone 600 in views similar to those used for microphone 500 in FIGS. 5A and 5B. Pilot beams 652 are indicative of pointing direction 124 and may be used to align pointing direction 124 in apparatus 100. Each pilot beam 652 may be parallel to pointing direction 124. Each light source 650 may be a laser diode or a light-emitting diode. Light sources 650 may be mounted on plate 530, as shown in FIG. 6A, or elsewhere on or in microphone 600. Each microphone 600 may have pilot beams 652 of a common color that is different from the colors of pilot beams 652 of the other microphones 600. With such color coding, pilot beams 652 of respective microphones 600 may be easily distinguished on workpiece 190.

In the example depicted in FIG. 6B, microphone 600 includes four light sources 650. More generally, microphone 600 may include any number of light sources 650 greater than or equal to one. However, it may be advantageous to implement a plurality of light sources 650 and arrange this plurality of light sources 650 about pointing direction 124 so as to most-clearly indicate pointing direction 124. It is also preferable that pilot beams 652 are either parallel to pointing direction 124 or deviate from pointing direction in manner that easily conveys pointing direction 124. For example, all light sources 650 may be positioned on a diameter that is centered on pointing direction 124 and angled toward pointing direction 124 by the same amount.

One or more acoustic sensors 120 of apparatus 100 may be a piezoelectric acoustic sensor instead of a microphone. Each such piezoelectric acoustic sensor may implement baffle 520 and plate 530, as discussed above in reference to FIG. 5. For example, in each of microphones 500 and 600, diaphragm 510 may be replaced by a piezoelectric transducer to form a piezoelectric acoustic sensor instead of a microphone. It is also possible to replace diaphragm 510 with an optical fiber. Acoustic signals 196 incident on this optical fiber impose a strain on the optical fiber. This strain may be detected through its effect on scattering of laser light propagating in the optical fiber.

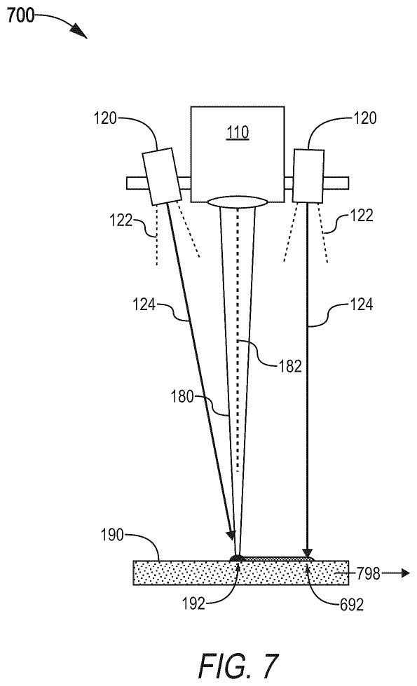

FIG. 7 illustrates an alternative configuration 700 of apparatus 100 wherein one or more acoustic sensors 120 are aimed at target location 192 (e.g., the focus of laser beam 180) and at least one other acoustic sensor 120 is aimed at another location away from target location 192. Configuration 700 may be useful in laser processing tasks that involve tracing a path, such as a line, with laser beam 180. In such tasks, at least one acoustic sensor 120 may be dedicated to monitoring of a recently-processed location 692 while this portion of workpiece 190 is still undergoing changes such as cooling.

In one line-welding scenario, workpiece 190 is translated in a direction 798 relative to processing head 110 while laser beam 180 irradiates workpiece 190. One or more acoustic sensors 120 are aimed at target location 192, that is, the location currently being processed by laser beam 180. At the same time, at least one other acoustic sensor 120 is aimed at recently-processed location 692 to listen for cracking in the material of the weld joint. In one example of this line-welding scenario, at least three acoustic sensors 120 are aimed at target location 192 while a single acoustic sensor 120 is aimed at recently-processed location 692. This example is readily extendable to laser processing tasks other than line welding.

Apparatus 100, including alternative configuration 700, may be modified to mount acoustic sensors 120 elsewhere than on processing head 110. In one modification, acoustic sensors 120 are mounted on workpiece 190. Workpiece-mounted acoustic sensors 120 are not as well suited for scenarios where a series of workpieces 190 are to be processed in quick succession, nor for scenarios where laser beam 180 traces an extended path on workpiece 190. On the other hand, mounting of acoustic sensors 120 to workpiece 190 may, at least in some scenarios, allow acoustic sensors 120 to be positioned closer to target location 192. The strength of acoustic emission 194 at the locations of acoustic sensors 120 may thereby be improved. In another modification, acoustic sensors 120 are mounted on a structure of apparatus 100 that is separate from both processing head 110 and workpiece 190. In one example, acoustic sensors 120 are mounted on a different structure of apparatus 100 that is in rigid connection with processing head 110. In another example, the collection of acoustic sensors 120 is mounted on one robotic arm, and processing head 110 is mounted on another robotic arm. In yet another example, processing head 110 includes internal beam-steering functionality, and acoustic sensors 120 are mounted on a robotic arm that can be adjusted to adapt to beam-steering of laser beam 180 by the internal beam-steering functionality of processing head 110.

The present invention is described above in terms of a preferred embodiment and other embodiments. The invention is not limited, however, to the embodiments described and depicted herein. Rather, the invention is limited only by the claims appended hereto.

What is claimed is:

1. An apparatus for laser processing a workpiece and monitoring the laser processing, comprising:
a laser processing head configured to direct a laser beam to a workpiece, the laser processing head including an objective lens configured to focus the laser beam;
a collection of three or more acoustic sensors attached to the laser processing head and distributed about an optical axis of the laser beam as incident on the workpiece, each of the acoustic sensors configured to produce an electrical signal in response to an acoustic signal incident thereon; and
a plurality of amplifiers, each (a) electrically connected to a respective one of the acoustic sensors, (b) configured to amplify the electrical signal from the respective acoustic sensor, and (c) having an independently adjustable gain.

2. The apparatus of claim 1, wherein the collection of acoustic sensors includes at least four acoustic sensors.

3. The apparatus of claim 1, further comprising a control system configured to receive a user input and set the independently adjustable gain of each of one or more of the amplifiers according to the user input.

4. The apparatus of claim 3, wherein:
the control system includes a graphical user interface configured to present a discrete set of values for the gain of each respective amplifier; and
the user input includes, for one or more of the amplifiers, a respective value of the gain as selected on the graphical user interface.

5. The apparatus of claim 1, wherein each of the acoustic sensors includes a respective microphone having a respective diaphragm configured to vibrate in response to the acoustic signal when incident thereon.

6. The apparatus of claim 5, wherein each of the microphones includes:
a respective baffle limiting a field of view of the microphone, and
a respective plate covering a receiving aperture of the baffle, the plate having a plurality of through holes.

7. The apparatus of claim 6, wherein each of the plurality of through holes has a diameter of no more than one millimeter.

8. The apparatus of claim 1, wherein each of the acoustic sensors is sensitive to acoustic frequencies greater than 20 kilohertz.

9. The apparatus of claim 1, wherein each of the acoustic sensors is sensitive to acoustic frequencies up to at least 50 kilohertz.

10. The apparatus of claim 1, further comprising, for each of the acoustic sensors, a respective spectral filter configured to filter frequency-content of the electrical signal from the acoustic sensor, the respective spectral filter being independently configurable.

11. The apparatus of claim 10, wherein a first spectral filter for at least one of the acoustic sensors is configured to exclude frequencies less than 20 kilohertz.

12. The apparatus of claim 11, wherein the first spectral filter is a high-pass filter.

13. The apparatus of claim 10, further comprising a control system configured to receive a user input and configure the spectral filter for each of one or more of the acoustic sensors according to the user input.

14. The apparatus of claim 1, further comprising:
for each of the acoustic sensors, a respective analog-to-digital converter configured to convert the electrical signal from analog to digital form; and
a control system configured to receive a user input and set a sampling rate for each of one or more of the respective analog-to-digital converters according to the user input.

15. The apparatus of claim 1, further comprising beamforming circuitry configured to process the electrical signals from at least three acoustic sensors of the collection to optimize a collective sensitivity of the at least three acoustic sensors to acoustic signals originating from a single location.

16. The apparatus of claim 1, wherein the collection of acoustic sensors includes:
at least three acoustic sensors that are (a) physically aimed at a focus location of the laser beam or (b) collectively aimed at a focus location of the laser beam by virtue of beamforming; and
another acoustic sensor aimed at a different location than the focus location.

17. The apparatus of claim 1, further comprising, for each of the acoustic sensors, a respective plurality of light sources arranged about a pointing direction of the acoustic sensor and configured to emit pilot beams indicating the pointing direction of the acoustic sensor.

18. The apparatus of claim 1, further comprising a plurality of optical sensors configured to detect at least a portion of optical radiation propagating backwards toward the laser processing head.

19. A method for laser processing a workpiece and monitoring the laser processing, comprising steps of:
directing a laser beam from a laser processing head to a workpiece;
focusing the laser beam with an objective lens of the laser processing head;
detecting acoustic emission from the workpiece with a collection of three or more acoustic sensors attached to the laser processing head and distributed about an optical axis of the laser beam as incident on the workpiece, said detecting including each acoustic sensor producing an electrical signal in response to an acoustic signal incident thereon;
amplifying the electrical signal from each of the acoustic sensors; and
adjusting, independently for each of the acoustic sensors, a gain of the amplifying step.

20. The method of claim 19, further comprising a step of receiving a user input specifying, for each of one or more of the acoustic sensors, the respective gain to be applied in the amplifying step.

21. The method of claim 20, further comprising a step of displaying, to a user, a discrete set of values of the gain for each of the acoustic sensors, and wherein the receiving step includes receiving, for each of the acoustic sensors, a respective one of the displayed values of the gain.

22. The method of claim 19, wherein the step of detecting includes detecting acoustic emission at acoustic frequencies up to at least 50 kilohertz.

23. The method of claim 19, further comprising a step of spectrally filtering the electrical signal for each acoustic sensor.

24. The method of claim 23, wherein the step of spectrally filtering, for at least one of the acoustic sensors, excludes acoustic frequencies less than 20 kilohertz.

25. The method of claim 23, wherein:
the electrical signal produced by at least one of the acoustic sensors includes a first acoustic feature characterized by an acoustic frequency of less than 20 kilohertz; and
the step of spectrally filtering, for the at least one acoustic sensor, retains a second acoustic feature at a harmonic of the acoustic frequency of the first acoustic feature and excludes the first acoustic feature.

26. The method of claim 19, further comprising a step of converting the electrical signal from analog to digital form for each of the acoustic sensors, wherein the step of converting, for at least one acoustic sensor, samples the corresponding electrical signal at a sampling rate of at least 100 kilohertz.

27. The method of claim 26, further comprising, after performing the steps of detecting, amplifying, and converting for N acoustic sensors of the collection of acoustic sensors, interlacing the electrical signals from the N acoustic sensors to generate an electrical output signal that samples the acoustic emission from the workpiece at a sampling rate of at least N×100 kilohertz, N being an integer greater than one.

28. The method of claim 26, further comprising a step of receiving a user input specifying, for each of one or more of the acoustic sensors, a respective rate at which the step of converting samples the electrical signal.

29. The method of claim 19, further comprising aiming at least three acoustic sensors of the collection at a target location where the laser beam is incident on the workpiece.

30. The method of claim 29, further comprising beamforming the electrical signals produced by the at least three acoustic sensors to optimize a collective sensitivity of the at least three acoustic sensors to the target location.

31. The method of claim 29, further comprising:
tracing a path on the workpiece with the laser beam; and
aiming another acoustic sensor, of the collection of acoustic sensors, at a location on the path previously processed by the laser beam.

32. The method of claim 19, further comprising detecting optical radiation propagating backwards from the workpiece toward the laser processing head.
